(19) United States
(12) Patent Application Publication
(10) Pub. No.: US 2016/0230888 A1
(43) Pub. Date: Aug. 11, 2016

(54) ACTUATOR

(71) Applicant: SCHAEFFLER TECHNOLOGIES AG & CO.KG, Herzogenaurach (DE)

(72) Inventors: Lars Schumann, Buehl (DE); Lászlo Mán, Ottersweier-Unzhurst (DE); Peter Greb, (US)

(73) Assignee: Schaeffler Technolgies AG & Co. KG, Herzogenaurach (DE)

(21) Appl. No.: 15/022,179

(22) PCT Filed: Aug. 8, 2014
(86) PCT No.: PCT/DE2014/200392

§ 371 Date: Mar. 15, 2016

(30) Foreign Application Priority Data
Sep. 25, 2013 (DE) 10 2013 219316.5

(51) Int. Cl. F16H 63/16; F16H 3/00

(52) U.S. Cl. CPC F16H 63/16; F16H 3/006

(57) ABSTRACT

An actuator for actuating a transmission to select a transmission ratio and to engage or disengage the selected transmission ratio and/or for actuating at least one clutch, with a cylindrical control element on which a first ring element for controlling the clutch, a second ring element as a drive element, a third ring element for shift control, and a fourth ring element for shift operation are disposed for rotation, wherein the first ring element is connected to a clutch for actuating the clutch upon a rotation of the first ring element, the second ring element is connected to a drive for rotating the second ring element, the third ring element is provided with actuating means interacting with corresponding actuating means of the first, second, and fourth ring element, and wherein the fourth ring element is connected to shifting elements of a transmission for shifting a transmission ratio.

### CROSS-REFERENCE TO RELATED APPLICATIONS

The present application is the U.S. national stage application pursuant to 35 U.S.C. §371 of International Patent Application No. PCT/DE2014/200392, filed Aug. 8, 2014, which application claims priority from German Patent Application No. 10 2013 219 316.5, filed Sep. 25, 2013, which applications are hereby incorporated by reference in their entireties.

### BACKGROUND OF THE INVENTION

The invention relates to an actuator, in particular for actuating a transmission to select a transmission ratio and to engage or disengage the selected transmission ratio and/or for actuating a clutch. The invention further relates to a transmission including at least one actuator of this kind.

Various actuators for transmissions or clutches are known in the art.

DE 196 55 083 B4 discloses an actuator for a transmission with a controller drum integrated into the transmission housing. The clutch actuator is designed to be separate therefrom.

WO 97/02963 discloses an actuator for a transmission and a clutch wherein the actuation of the transmission and the actuation of the clutch are carried out by means of actuators that are separate from one another.

WO 02/066870 A1 discloses a transmission actuation wherein a transmission ratio is disengaged in an automated way when a different transmission ratio is engaged.

### SUMMARY OF THE INVENTION

An object of the invention is to provide an actuator for a transmission that is of simple and cost-efficient construction.

An exemplary embodiment of the invention relates to an actuator, in particular for actuating a transmission to select a transmission ratio and to engage or disengage the selected transmission ratio and/or for actuating at least one clutch, with at least one cylindrical control element on which at least a first ring element for controlling the clutch, a second ring element as a drive element, a third ring element for shift control, and a fourth ring element for shift actuation are disposed for rotation, wherein the first ring element is connected to a clutch for actuating the clutch upon a rotation of the first ring element, the second ring element is connected to a drive for rotating the second ring element in a controlled and driven way, the third ring element is provided with actuating means interacting with corresponding actuating means of the first, second, and fourth ring element, and wherein the fourth ring element is connected to shifting elements of a transmission for shifting a transmission ratio. The first ring element and/or the third ring element may be rotated by a rotation of the second ring element. The clutch may be actuated by a rotation of the first ring element. The fourth ring element may be actuated by a rotation of the third ring element, causing the transmission to be actuated to select a transmission ratio and to engage or disengage a transmission ratio.

In this context it is advantageous if the cylindrical control element has at least one protruding tab acting as a rotation stop of the first ring element, wherein the first ring element has at least one contact surface that rests against the tab when the ring element is in a defined position relative to the control element.

In accordance with the invention, it is preferred if the cylindrical control element is a stationary element, which is fixedly connected to the transmission housing, for instance, and is not disposed for rotation. On this cylindrical control element, the ring elements are received for rotation; individual ring elements are rotatable only through a limited angle of rotation, whereas other ring elements are rotatable in one or both directions, in particular through 360° or more than 360°.

It is particularly advantageous if the ring elements are disposed adjacent to one another as viewed in an axial direction of the control element.

It is further expedient if the second ring element has means connected to drive means of a drive to drive the second ring element in a first or in a second direction of rotation.

It is particularly advantageous if the means are or comprise a circumferential toothing meshing with a gear of the drive. Thus the second ring element may easily be driven to rotate in the one or in the other direction of rotation.

In accordance with the invention, it is further advantageous if the second ring element has recesses through which actuating means of the third ring element extend in an axial direction. The third ring element may drive the first ring element if the actuating means pass through the recess and protrude out of the latter and in a different mode of operation, the third ring element may not drive the first ring element if the actuating means do not protrude out of the recess.

It is further expedient if the third ring element has first actuating means that extend to the second ring element in an axial direction and if the third ring element has second actuating means that extend to the fourth ring element in an axial direction.

It is particularly advantageous if the first actuating means of the third ring element extend through the recesses of the second ring element. These then serve to actuate the first ring element.

It is further advantageous if the first actuating means of the third ring element has a contact surface interacting with a contact surface of the first ring element. In this way, the first ring element may be displaced by means of the third ring element.

It is particularly advantageous if the contact surface of the first ring element and the contact surface of the third ring element are disposed to be inclined in a circumferential direction.

It is further advantageous if the second actuating means of the third ring element are designed to have contact surfaces interacting with contact surfaces of the actuating means of the fourth ring element. Thus the third ring element may interact with the fourth ring element to displace the latter.

It is further advantageous if the second actuating means of the third ring element are embodied as tabs that protrude in an axial direction and if the actuating means of the fourth ring element are recesses in which the actuating means of the third ring element engage.

In accordance with the invention it is advantageous if the cylindrical control element and the third ring element have ramp elements that interact with one another in a pre-defined relative position of the control element and the third ring element. In this process, the third ring element is lifted by means of the ramp elements, causing the actuating means of the third ring element to disengage from the recesses of the fourth ring element.

It is further advantageous if the fourth ring element is a roller element that has at least one guide track or guide tracks disposed on its outer circumference and/or on an end face. Thus the fourth ring element may be embodied as a controller drum whose guide tracks are engaged by shifting means of the transmission to cause an actuating element of the transmission to be actuated when the contour of the guide track changes.

It is further advantageous if an energy storage element is provided between the second ring element and the third ring element to pre-load the two ring elements away from one another.

An exemplary embodiment of the invention relates to a transmission with a plurality of transmission ratios and with at least one clutch, characterized by at least one actuator.

In this context, it is advantageous if two actuators are provided to select a transmission ratio and to engage or disengage the selected transmission ratio and/or to actuate two clutches.

It is further advantageous if the transmission is a double clutch transmission.

The present invention will be explained below based on preferred exemplary embodiments and in connection with the associated figures.

### BRIEF DESCRIPTION OF THE DRAWINGS

The invention will he explained in greater detail in the following section on the basis of exemplary embodiments, with reference to the appended drawings in which:

FIG. 1 is a diagrammatic perspective view of an actuator;

FIG. 2 is a diagrammatic sectional view of the actuator;

FIG. 3 is a diagrammatic partial representation of the actuator;

FIG. 4 is a diagrammatic representation of the actuator in a first operating position;

FIG. 5 is a diagrammatic representation of the actuator in a second operating position;

FIG. 6 is a diagrammatic representation of a cylindrical control element;

FIG. 7 is a diagrammatic representation of the first ring element;

FIG. 8 is a diagrammatic representation of the fourth ring element;

FIG. 9 is a diagrammatic representation of the third ring element;

FIG. 10 is a diagrammatic representation of the second ring element;

FIG. 11 is a representation of a translatory model for explaining the invention;

FIG. 12 is a representation of a translatory model for explaining the invention;

FIG. 13 is a representation of a translatory model for explaining the invention;

FIG. 14 is a representation of a translatory model for explaining the invention;

FIG. 15 is a representation of a translatory model for explaining the invention;

FIG. 16 is a representation of a translatory model for explaining the invention;

FIG. 17 is a representation of a translatory model for explaining the invention;

FIG. 18 is a representation of a translatory model for explaining the invention;

FIG. 19 is a representation of a translatory model for explaining the invention;

FIG. 20 is a representation of a translatory model for explaining the invention; and,

FIG. 21 is a representation of a translatory model for explaining the invention.

### DETAILED DESCRIPTION OF THE INVENTION

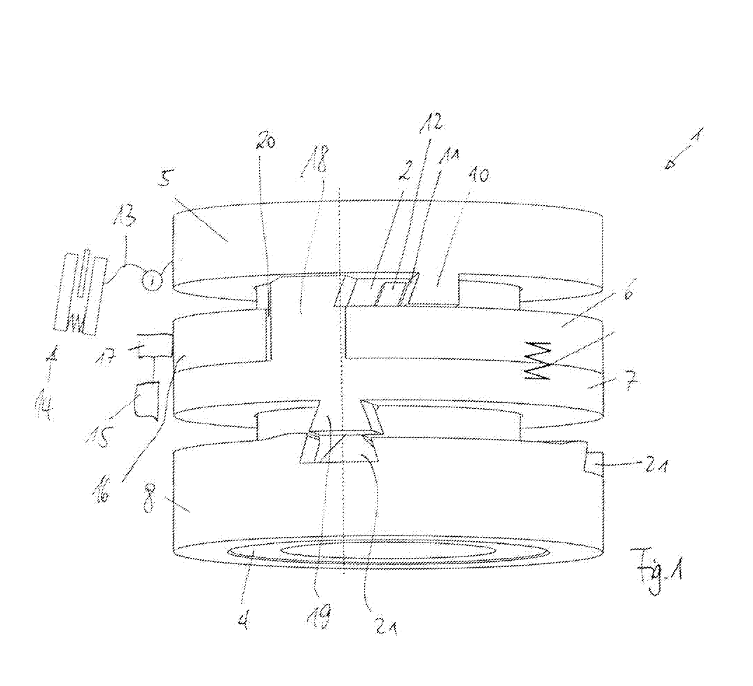

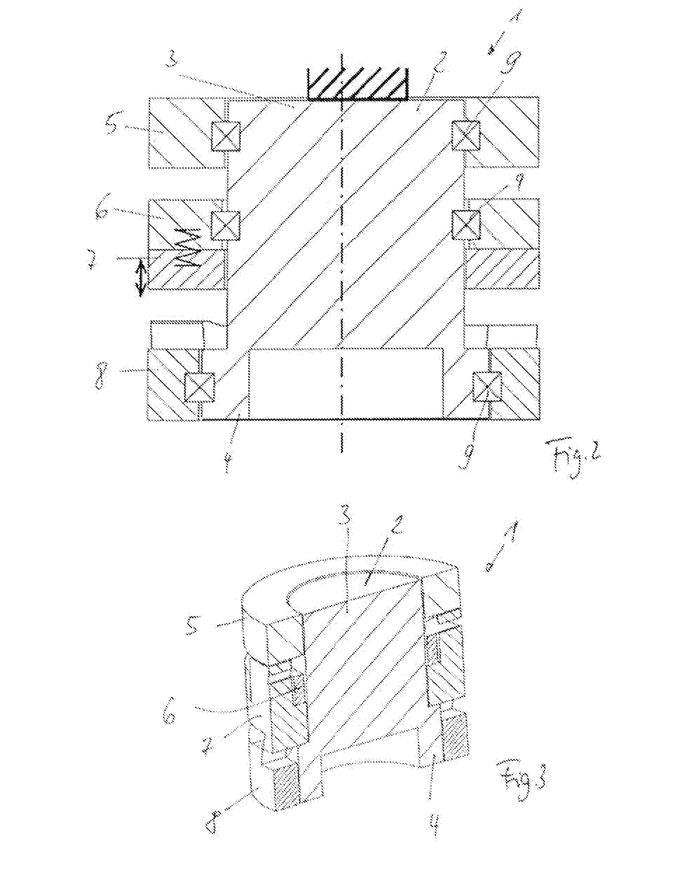

FIGS. 1 to 3 are a perspective view, a sectional view, and a partial perspective view, respectively, of actuator 1 of the invention. Actuator 1 has cylindrical control element 2, which has cylindrical first region 3 and cylindrical second region 4 protruding in a radially outward direction therefrom. Cylindrical control element 2 receives ring elements 5, 6, 7, 8 for rotation on its outer circumference. Ring element 5, ring element 6, and ring element 8 are positioned to be axially fixed and rotatable and are connected for rotation with cylindrical control element 2 by means of bearings 9. Ring element 7 is disposed for axial displacement and rotation relative to cylindrical control element 2.

As it is apparent from FIG. 1, ring element 5 has actuating means 10 with contact surface 11 capable of interacting with protruding tab 12 of cylindrical control element 2 to limit a relative rotation of ring element 5 relative to control element 2. When contact surface 11 gets into contact with tab 12, ring element 5 is fixed in a circumferential direction. However, ring element 5 may be rotated out of this position shown in FIG. 1 by a rotation towards the right.

Ring element 5 serves to actuate a clutch and is thus connected to a clutch actuating element for controlling the clutch; this is diagrammatically indicated by connection 13 to clutch 14.

Ring element 6 serves as a drive element that is in driving connection with drive 15. Ring element 6 may be driven in a first direction of rotation or in the opposite second direction of rotation by means of drive 15. For this purpose, ring element 6 preferably has means 16 that are in driving connection with drive means 17 of drive 15 to drive ring element 6 in the first or second directions of rotation. Means 16 may be a gear or a toothing meshing with a toothing of drive 15. In a corresponding way, drive 15 may rotate ring element 6 to drive ring element 5 and/or ring element 8.

Ring element 7, which is disposed adjacent to ring element 6 and is provided with actuating means 18, 19 interacting with ring element 5 or with ring element 8, is provided to drive ring element 5 or ring element 8. Ring element 6 has recesses 20, which receive actuating means 18 of ring element 6. Actuating means 18 are designed in such a way that they may respectively extend through recess 20 in an axial direction.

Actuating means 18 have a first region that is essentially rectangular when viewed from the side and a second region embodied as an end region and inclined on one flank to be capable of interacting with contact surface 11 of actuating means 10 of ring element 5. When actuating means 18 extends through recess 20 and protrudes from recess 20, actuating means 18 may get into contact with contact surface 11 upon a rotation of ring element 6, and upon a further rotation, ring element 5 may be rotated in this way. If, after a rotation of ring element 5 to the right, ring element 6 is rotated to the left again, ring element 5 follows this rotation because ring element 5 is connected to clutch 14 and, due to the pre-loading of the clutch, a force is applied to ring element 5 in an indirect way so that in a not-actuated condition, contact surface 11 of ring element 5 gets into contact with tab 12.

If ring element 7 is displaced in an axial direction so that actuating means 8 does not protrude out of recess 20, ring element 6 may be rotated with ring element 7 without causing actuating means 18 to get into contact with support surface 11 and without causing ring element 5 to be co-rotated.

Ring element 7 further includes actuating means 19 that protrude in an axial direction and protrude from ring element 7 in the opposite direction from actuating means 18. Actuating means 19 may engage in recesses 21 as actuating means of ring element 8 to be capable of moving ring element 8 in the respective direction of rotation when actuating means 19 engages in recess 21. For this purpose, actuating means 19 are embodied to have a trapezoidal shape, having opposing inclined contact surfaces, which in turn get into contact with inclined contact surfaces associated with recesses 21.

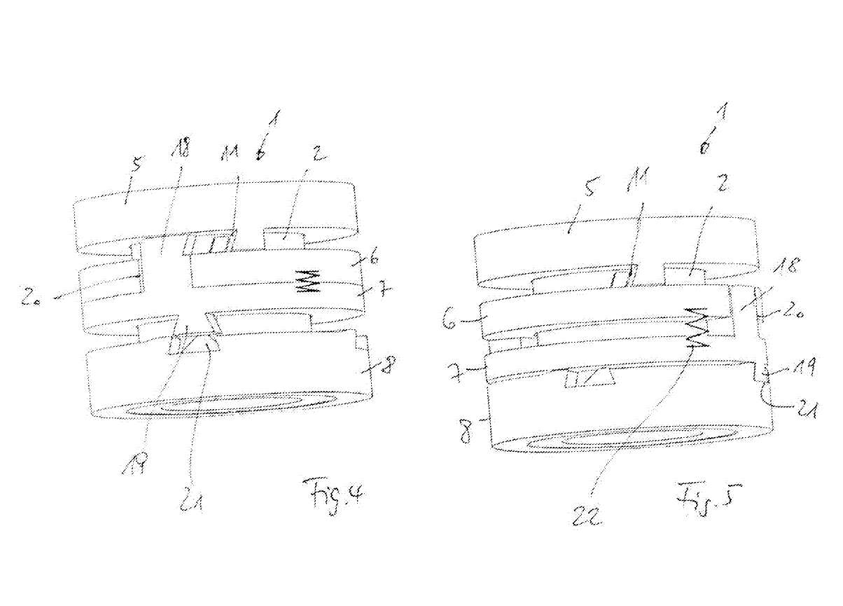

FIGS. 4 and 5 illustrate actuator 1 in various actuating positions. In FIG. 4, which essentially corresponds to FIG. 1, ring element 7 is disposed adjacent to ring element 6 in such a way that actuating means 18 extends through recess 20 and protrudes from recess 20 to be capable of getting into contact with contact surface 11 of ring element 5. Simultaneously, actuating means 19 is outside recesses 21 of the actuating means of ring element 8.

In FIG. 5, ring element 7 is moved towards ring element 8 in an axial direction, causing ring element 6 and ring element 7 to be spaced apart. Due to this spacing, actuating means 18 only extends into recess 20 but does not protrude from recess 20. Thus, contact surface 11 of ring element 5 cannot be acted upon and actuating means 18 may be guided past contact surface 11 by a rotation of ring element 6. In this arrangement of ring element 7, actuating means 19 is simultaneously introduced into recess 21 so that by rotating ring element 6, ring element 7 and consequently also ring element 8 is disposed to be rotatable.

Energy storage element 22 is provided between ring element 6 and ring element 7 to apply a load to ring elements 6, 7 relative to one another in a way to urge ring element 7 away from ring element 6 and towards ring element 8.

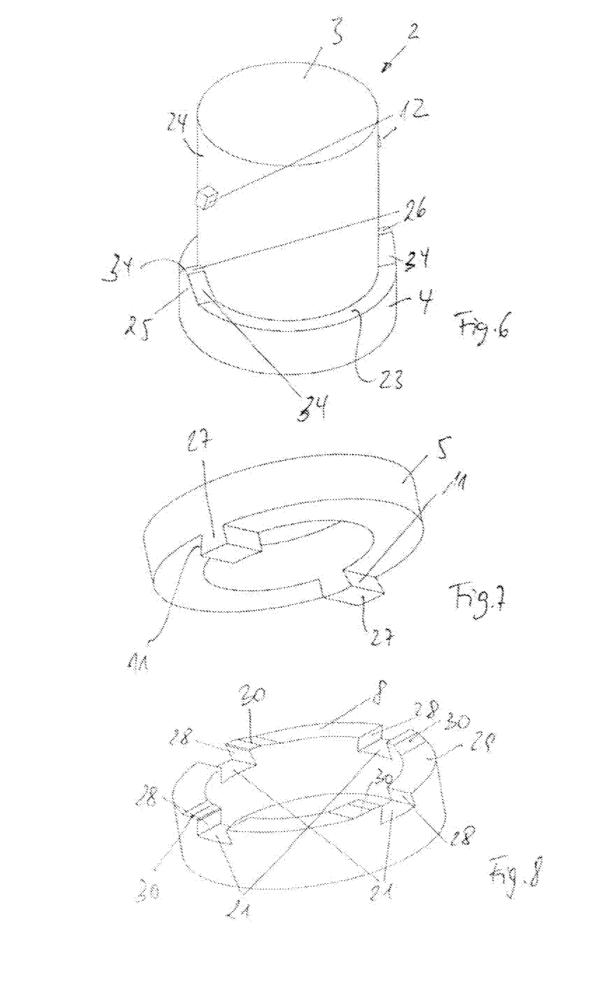

FIG. 6 illustrates cylindrical control element 2 with cylindrical region 3 and cylindrical region 4. Cylindrical region 3 transitions into cylindrical region 4 at shoulder 23. Tab 12 serving as a stop for contact surface 11 of ring element 5 is disposed on lateral cylinder surface 24 of cylindrical region 3. Preferably, two tabs 12 opposing one another at 180° are provided on lateral surface 24 of cylindrical region 3. Shoulder 23 is essentially perpendicular, with ramp surfaces 34 provided in the region of shoulder 23 to create raised portion 25 in sections of the circumference of shoulder 23. There are preferably 2 opposing ramp surfaces 34 that are connected to raised plane 26. FIG. 7 illustrates ring element 5 with the protrusions embodied as actuating means 27 and axially protruding from ring element 5. Lateral flanks form contact surfaces 11 for contact with a flank of tab 12 or with a flank of actuating means 18 of ring element 7. FIG. 8 illustrates ring element 8 with essentially trapezoidal recesses 21 that have side flanks 28 for contacting flanks of actuating means 19 of ring element 7. Annular upper side 29 is interrupted by recesses 21 and does not have a uniform height: on one side of recesses 21, upper side 29 rises, forming raised portion 30. When actuating means 19 is contacted on the upper side and when actuating means 19 is displaced to the left, this raised portion 30 causes a side flank of actuating means 19 to get into contact with side flank 28 in the region of raised portion 30 and prevents any further rotation on the surface of upper side 29 so that actuating means 19 is engaged in recess 21.

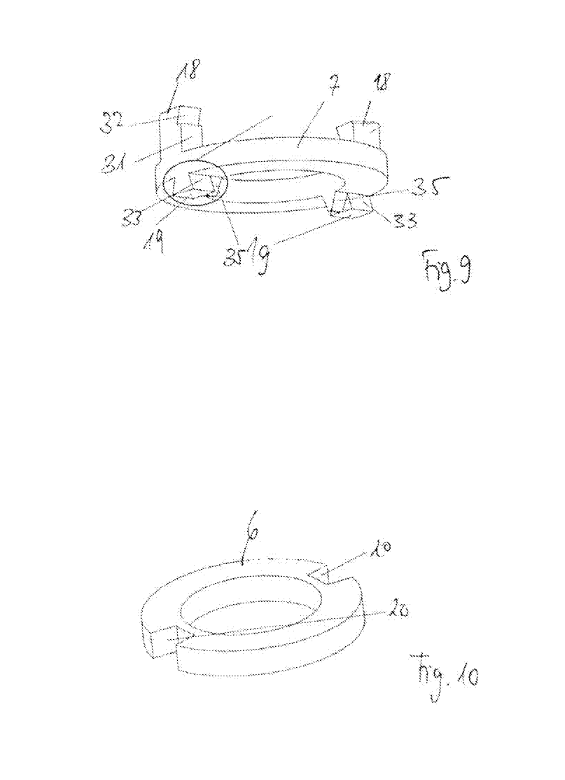

FIG. 9 illustrates ring element 7 with actuating means 18 that protrude upwards in an axial direction. Actuating means 18 has straight side flanks 31 and angled side flanks 32. Angled side flanks 32 serve to contact contact surfaces 11 of ring element 5 and straight side flanks 31 serve to contact recesses 20 of ring element 6. Actuating means 19 extend away from ring element 7 in the opposite direction of actuating means 18 and are of trapezoidal shape, including side flanks 33. Side flanks 33 serve as contact surfaces by means of which actuating means 19 may get into contact with the side flanks of recesses 21 of ring element 8 to cause the transmission of force between ring element 7 and ring element 8.

In addition, ramp surfaces 35 are provided radially inside actuating means 19. Upon a rotation of ring element 7 relative to cylindrical control element 2, these ramp surfaces 35 get into contact with ramp surfaces 34, causing ring element 7 to rise relative to control element 2 and actuating means 19 to disengage from recesses 21 of ring element 8 upon contact between ramp surfaces 34, 35.

FIG. 10 illustrates ring element 6 as a ring element with recesses 20 that are open towards the outside in which actuating means 18 of ring element 7 may engage.

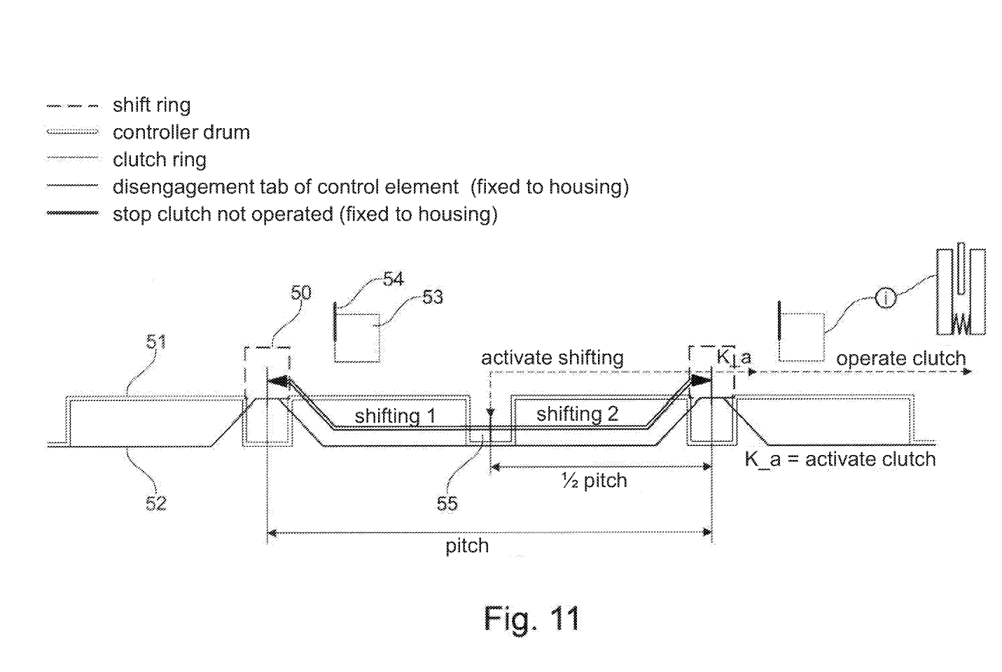

FIGS. 11 to 15 explain the functioning of actuator 1 in a translatory analogous model. A driven shifting element that is movable in a lateral direction is represented as shift ring 50. The lateral movement corresponds to the rotation of the component. 51 indicates the controller drum and 52 indicates the disengagement tab of cylindrical control element 2. In this context, controller drum 51 is represented as ring element 8 and the disengagement tab is represented as ramp surface 34 or raised portion 25 of cylindrical control element 2. If control element 50 moves against a contact surface of clutch actuating element 53, which is embodied as ring element 5, the clutch can be actuated by displacing clutch actuating element 53. If there is no actuation of the clutch, the clutch actuating element is in contact with stop 54. If control element 50 moves into recess 55 of the controller drum, controller drum 51 may be moved or rotated upon a further rotation or movement of control element 2. If controller drum 51 moves relative to disengagement tab 52, control element 50 is guided out of recess 55 again.

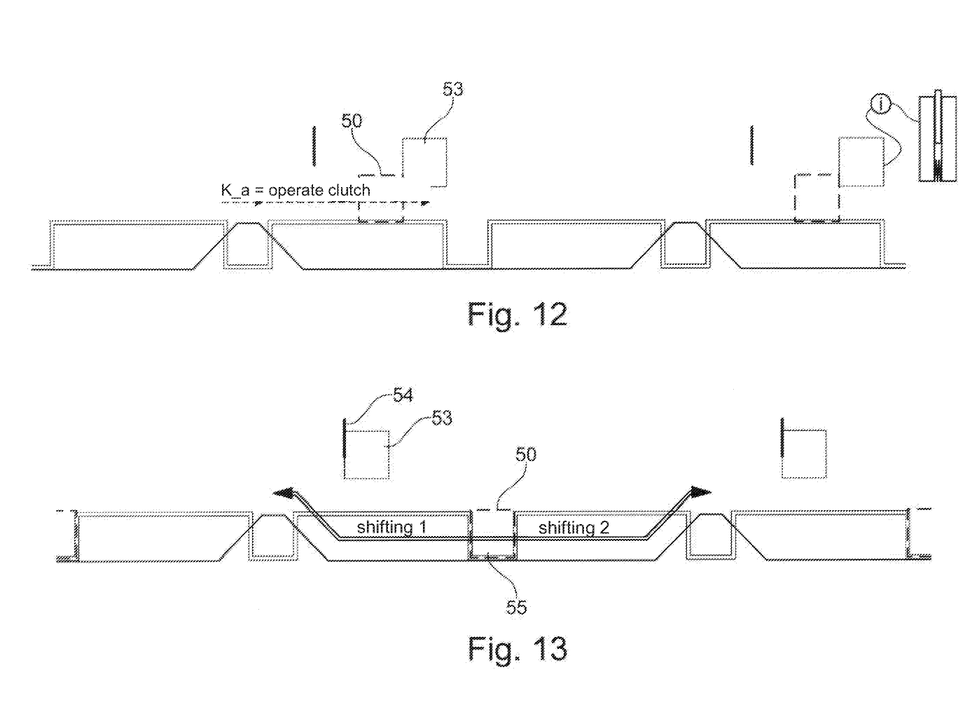

FIG. 11 shows that the control element is disposed outside recess 55 of controller drum 51; the clutch is not actuated. FIG. 12 shows control element 50 in contact with a contact surface of clutch actuating element 53, so that upon a further movement, clutch actuating element 53 is displaced so that the clutch is actuated.

FIG. 13 shows control element 50 with the clutch not actuated, i.e., the clutch actuating element is in contact with stop 54, introduced into recess 55 so that upon a further displacement of control element 50 towards the right or towards the left, a shifting actuation to a first transmission ratio or a shifting actuation in a second transmission ratio may occur.

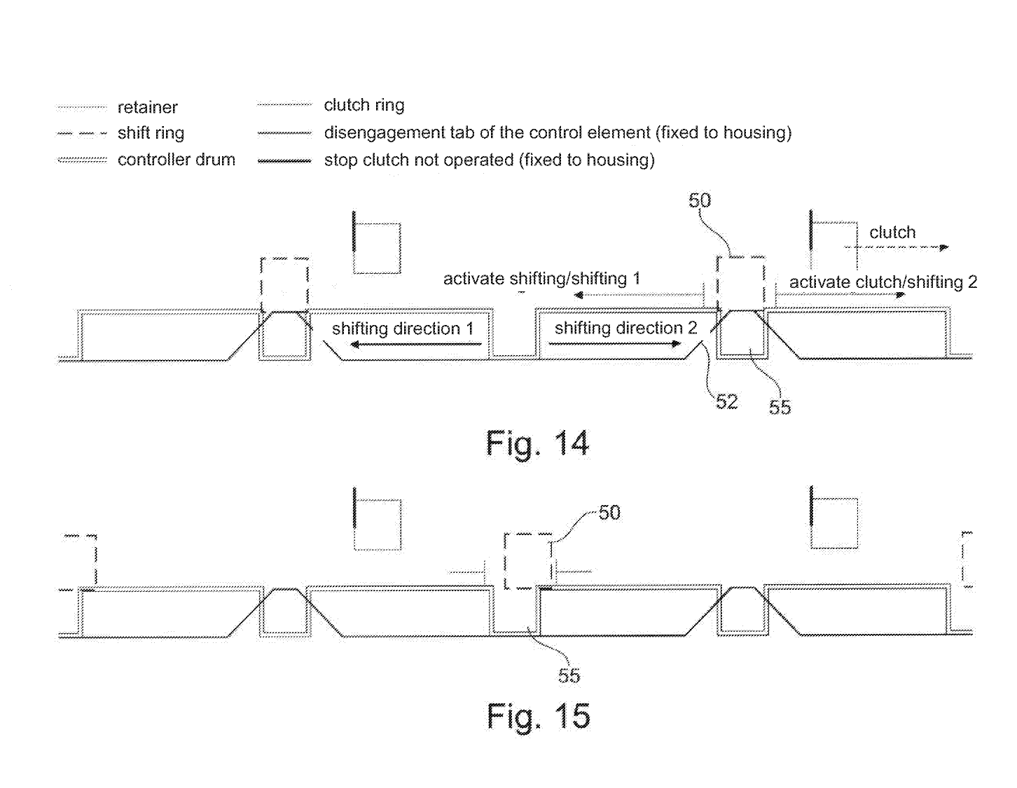

FIG. 14 shows the control element disengaged from recess 55 after disengagement via disengagement tab 52 so that subsequently an activation of the clutch or a shifting operation is possible by a movement into a further recess.

FIG. 15 shows control element 50 moved in the direction of recess 55 from a different position while the clutch is not actuated.

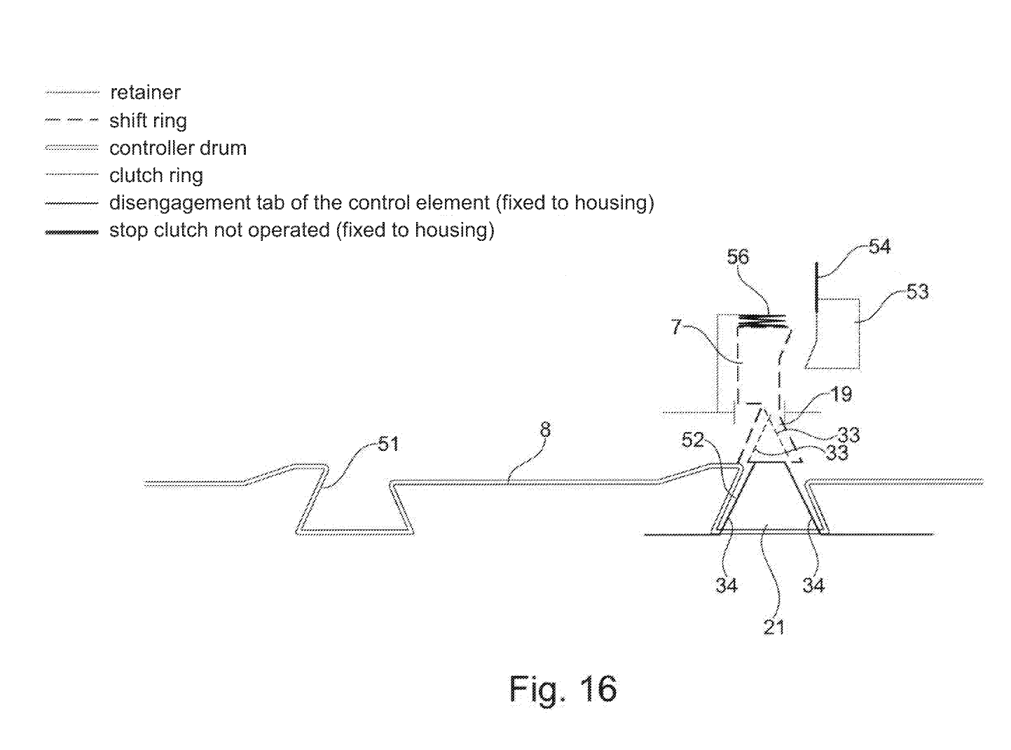

FIG. 16 shows actuating means 19 of ring element 7 upon an engagement process with recess 21 of ring element 8. Here, the controller drum is indicated at 51, the disengagement tab at 52, and the clutch actuating element with stop at 53 and 54, respectively. Actuating means 19 of ring element 7 is spring-loaded by energy storage element 56 and pre-loaded in the direction of the controller drum/ring element 8. Actuating means 19 is in contact with the disengagement tab so that a further rotation of actuating means 19 results in an actuation of the clutch or in an engagement with recess 21.

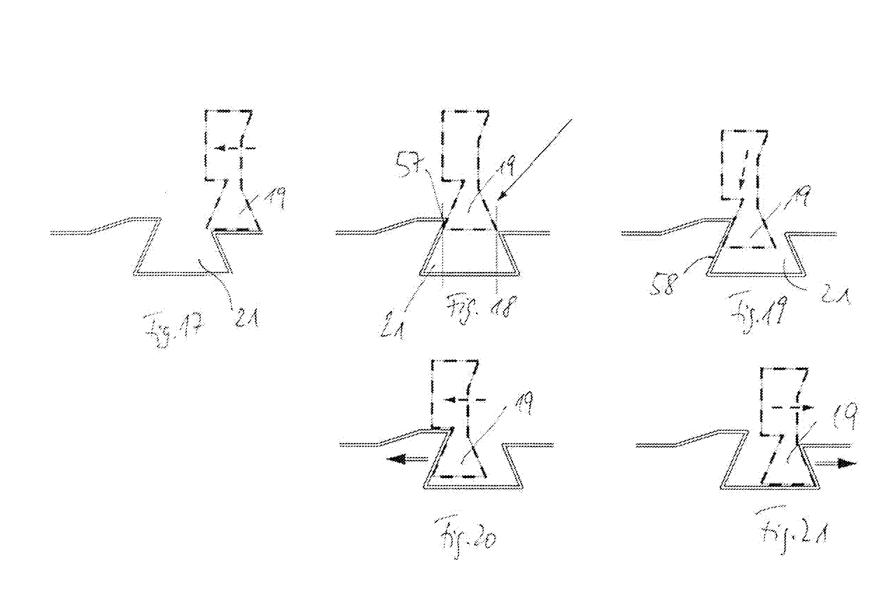

FIG. 17 illustrates the movement of actuating means 19 into recess 21 to engage in the recess. FIG. 18 illustrates actuating means 19 having moved above recess 21 and in contact with flank 57 of recess 21. Upon a further displacement of actuating means 19 towards the left as shown in FIG. 19, actuating means 19 moves into recess 21 along flank 58 of recess 21. Upon a displacement of actuating means 19 towards the left as shown in FIG. 20, a first transmission ratio is activated or upon a displacement of actuating means 19 towards the right a second transmission ratio may be activated.

### LIST OF REFERENCE NUMERALS

1 actuator
2 control element
3 first cylindrical region
4 second cylindrical region
5 first ring element
6 second ring element
7 third ring element
8 fourth ring element
9 bearing
10 actuating means
11 contact surface
12 tab
13 connection
14 clutch
15 drive
16 means
17 drive means
18 actuating means
19 actuating means
20 recess
21 recess
22 energy storage element
23 shoulder
24 lateral cylinder surface
25 raised portion
26 raised plane
27 actuating means
28 side flank
29 upper side
30 raised portion
31 side flank
32 side flank
33 side flank
34 ramp surface
35 ramp surface
50 control element
51 controller drum
52 disengagement tab
53 clutch actuating element
54 stop
55 recess
56 energy storage element
57 flank
58 flank

What is claimed is:

1-17. (canceled)

18. An actuator, in particular for actuating a transmission to select a transmission ratio and to engage or disengage the selected transmission ratio and/or to actuate at least one clutch, comprising:
at least one cylindrical control element on which at least one first ring element for controlling the clutch, a second ring element as a drive element, a third ring element for shift control, and a fourth ring element for shift operation are disposed for rotation;
wherein the first ring element is connected to a clutch to actuate the clutch upon a rotation of the first ring element, the second ring element is connected to a drive for a controlled, driven rotation of the second ring element, the third ring element is provided with actuating means interacting with corresponding actuating means of the first, second, and fourth ring element, and the fourth ring element is connected to shifting elements of a transmission for shifting a transmission ratio.

19. The actuator of claim 18, wherein the at least one cylindrical control element has at least one protruding tab that serves as a rotation stop of the first ring element, wherein the first ring element has at least one contact surface that rests against the at least one protruding tab in a defined position of the first ring element relative to the at least one cylindrical control element.

20. The actuator of claim 18, wherein the second ring element has means that are connected to drive means of a drive to drive the second ring element in a first direction of rotation or in a second direction of rotation.

21. The actuator of claim 20, wherein the means are a circumferential toothing meshing with a gear of the drive.

22. The actuator of claim 18, wherein the second ring element has recesses through which actuating means of the third ring element extend in an axial direction.

23. The actuator of claim 18, wherein the third ring element includes first actuating means that extend in an axial direction to the second ring element and the third ring element has second actuating means that extend in an axial direction to the fourth ring element.

24. The actuator of claim 22, wherein first actuating means of the third ring element extend through the recesses of the second ring element.

25. The actuator of claim 23, wherein the first actuating means of the third ring element has a contact surface that interacts with a contact surface of the first ring element.

26. The actuator of claim 25, wherein the contact surface of the first ring element and the contact surface of the third ring element are disposed to be inclined in a circumferential direction.

27. The actuator of claim 23, wherein the second actuating means of the third ring element are embodied to have contact surfaces that interact with contact surfaces of the actuating means of the fourth ring element.

28. The actuator of claim 23, wherein the second actuating means of the third ring element are embodied as tabs that protrude in an axial direction and the actuating means of the fourth ring element are recesses in which the actuating means of the third ring element engage.

29. The actuator of claim 18, wherein the at least one cylindrical control element and the fourth ring element have ramp elements that interact with one another in a pre-defined relative position of the at least one cylindrical control element and the fourth ring element.

30. The actuator of claim 18, wherein the fourth ring element is a roller element that includes at least one guide track or guide tracks on its outer circumference and/or on an end face.

31. The actuator of claim 18, wherein an energy storage element pre-loading two ring elements away from one another with a pre-load is disposed between the second ring element and the third ring element.

32. A transmission with a plurality of transmission ratios and with at least one clutch including the actuator of claim 18.

33. The transmission of claim 32, wherein two actuators are provided to select a transmission ratio and to engage or disengage the selected transmission ratio and/or to actuate two clutches.

34. The transmission of claim 32, wherein the transmission is a double clutch transmission.
